(19) United States
(12) Patent Application Publication
(10) Pub. No.: US 2003/0011534 A1
(43) Pub. Date: Jan. 16, 2003

(54) Display privacy for enhanced presentations with real-time updates

(75) Inventors: Marco Michael Rengan, Chapel Hill, NC (US); Robert Russell Wolford, Durham, NC (US); Richard Joseph Zabelicky JR., Raleigh, NC (US)

Correspondence Address: BRACEWELL & PATTERSON LLP, Intellectual Property Law, P O Box 969, Austin, TX, 78767-0969, US

(73) Assignee: International Business Machines Corporation

(21) Appl. No.: 09/904,622

(22) Filed: Jul. 13, 2001

(51) Int. Cl. G09G 5/00

(52) U.S. Cl. 345/1.1

(57) ABSTRACT

An apparatus and method within a display subsystem for replacing a video image on a local display while simultaneously maintaining the first video image on an external display. The method entails configuring a first buffer address register accessible by a display controller to locally display data pointed to by the first buffer address register, and a second buffer address register accessible by the display controller to display within an external display device data pointed to by the second buffer address register. An active frame buffer stores graphic image contents for a local display. The first and second buffer address registers are programmed to point to the primary frame buffer during dual display mode. Responsive to selecting split display mode, the contents of the primary frame buffer are copied to a alternate frame buffer. Finally, the second buffer address register is set to point to the alternate frame buffer.

### BACKGROUND OF THE INVENTION

1. Technical Field

The present invention relates in general to a computer system having double display devices, such as one or two cathode ray tubes (CRTs), or one or two liquid crystal displays (LCDs), or a mix of one CRT and a LCD, for example. In particular, the present invention relates to a computer display system wherein either identical or different images may be displayed simultaneously to a user on a local LCD display device and to an audience on an external CRT device.

2. Description of the Related Art

As utilized herein, a “dual display computer system” encompasses, in general, the following functionality. The dual display system is incorporated in a portable computer such as a lap-top computer having a built-in display panel that is the first part of the dual display. The dual display system is provided with a means for connecting a second external display device such as a CRT display thereto. When the external display device is connected, the dual display computer system can display an identical image on its own display panel and on the external display unit at the same time. Such dual display systems are commonly utilized for providing presentations wherein a presenter can simultaneously face an audience and view a local display of a sequence of display screens while providing the same display screen sequence to an audience via the external display device.

With reference to FIG. 1, there is depicted a block diagram of a conventional dual display computer system 100. Although not explicitly shown in FIG. 1, it will be understood by those skilled in the art that such a system may be incorporated within personal computer systems such as portable lap-top computers, which are particularly useful for providing graphic display presentations. The internal video display data path processing functionality of dual display computer system 100 essentially includes a central processing unit (CPU) 115, a video memory device 112, a video display controller 110, and a digital-to-analog converter (DAC) 106.

In typical implementations, video display controller 110 and video memory device 112 are incorporated on a video adapter board (not depicted) that plugs into a personal computer. As depicted in FIG. 1, dual display computer system 100 further includes a local LCD device 104 for providing an onboard video display to a local user, and an external CRT display device 102 for providing an alternate video display to an audience, for example. The display capabilities of a personal computer in which dual display computer system 100 is implemented depend on both the logical circuitry (provided by video display controller 110 and video memory 112) and the display apparatus connected therewith (LCD device 104 and CRT display device 102). An external interface bus cable 108 connects CRT display device 102 with video display controller 110. DAC 106 converts digitally encoded images into analog signals that can then be displayed by CRT display device 102.

Modern video adapters contain their own memory, such as video memory device 112, so that the host computer's random access memory (RAM) is not depleted by graphic display storage. In addition, although not depicted in FIG. 1, most video adapters have their own graphics coprocessor for performing graphics-related computations. As illustrated in FIG. 1, video memory device 112 further comprises a frame buffer 114 having one or more output ports for providing a data path from video memory 112 to LCD device 104 and CRT display device 102.

In the configuration depicted, dual display computer system 100 includes switching means (not depicted) associated with frame buffer 114 for determining whether to send video data to LCD device 104 only, CRT display device 102 only, or both LCD device 104 and CRT display device 102 simultaneously. Typically, a dual display computer system does not include an option to freeze a current graphic display on CRT display device 102 while providing a next displayed item on LCD device 104. This is a significant practical limitation since it prevents a person providing a sequential visual presentation to an audience from previewing a locally displayed copy of the graphics file (usually an upcoming graphic) prior to actually displaying it to the audience.

A possible solution to this problem is to incorporate additional data path control circuitry to the video adapter to provide the requisite independence between the local LCD display and an external CRT display. Two such data path intervention techniques are described in U.S. Pat. No. 5,977,933, issued to Wicher et al. and U.S. Pat. No. 5,764,201, issued to Ranganathan. The split display method disclosed by Wicher et al. employs independent clocking to each display to enable a simultaneous display of different images as well as simultaneous display of the same image. However, extensive multiplexing and timing circuitry must be added to the video adapter card to implement the independent clocking. Another approach to providing a split display capability is disclosed by Ranganathan, wherein different data path formats are utilized to provide independent display capabilities. Dual data paths from video memory are applied to multiplexing circuitry, which either act in unison to display the same image on both the local LCD panel and the external CRT, or separately so that different images may be displayed on each of the displays. As with the technique described by Wicher, however, substantial additional multiplexing overhead circuitry must be added. In addition, the complexity of the video data path is greatly increased to accommodate two video data formats.

An alternative approach for providing a split display capability entails freezing a currently displayed graphic on one display unit (external CRT) while permitting the display unit (local LCD) to display a different graphic. Such an approach is set forth by Tsakiris in U.S. Pat. No. 5,736,968, wherein is described a computer based presentation system that allows a presenter to view on a monitor associated with a computer an image prior to its display on a television monitor or projection system to an audience. The system described therein includes a video frame buffer having an input coupled to a video port of the computer for receiving a video signal generated by the computer. The buffer captures and stores in memory a frame carried by the video signal. An output of the video buffer is connected to a video display adapter for continuously converting the stored image frame to a second video signal for transmission to the television monitor for display to an audience.

The additional hardware required to implement the system set forth by Tsakiris does not affect the extant video display adapter associated with the local display, and therefore for split display applications requiring independence to the extent that a locally displayed image can be changed while the external display is held static, the system described by Tsakiris may be preferable to those systems disclosed by Wicher et al. and Ranganathan. However, additional hardware overhead is required in that an additional video display adapter for the external display must be added.

It can therefore be appreciated that a need exists for an improved technique for simultaneously displaying different images on a local display device and an external display device without adding duplicate video display adapter functionality. The present invention addresses such a need.

### SUMMARY OF THE INVENTION

An apparatus and method within a display subsystem for replacing a first video image on a local display while simultaneously maintaining the first video image on an external display are disclosed herein. The method entails configuring a first buffer address register accessible by a display controller to locally display data pointed to by the first buffer address register, and a second buffer address register accessible by the display controller to display within an external display device data pointed to by the second buffer address register. An active frame buffer stores graphic image contents for a local display. The first and second buffer address registers are programmed to point to the primary frame buffer during dual display mode. Responsive to selecting split display mode, the contents of the primary frame buffer are copied to a static frame buffer. Finally, the second buffer address register is set to point to the static frame buffer.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram illustrating a conventional dual display computer system;

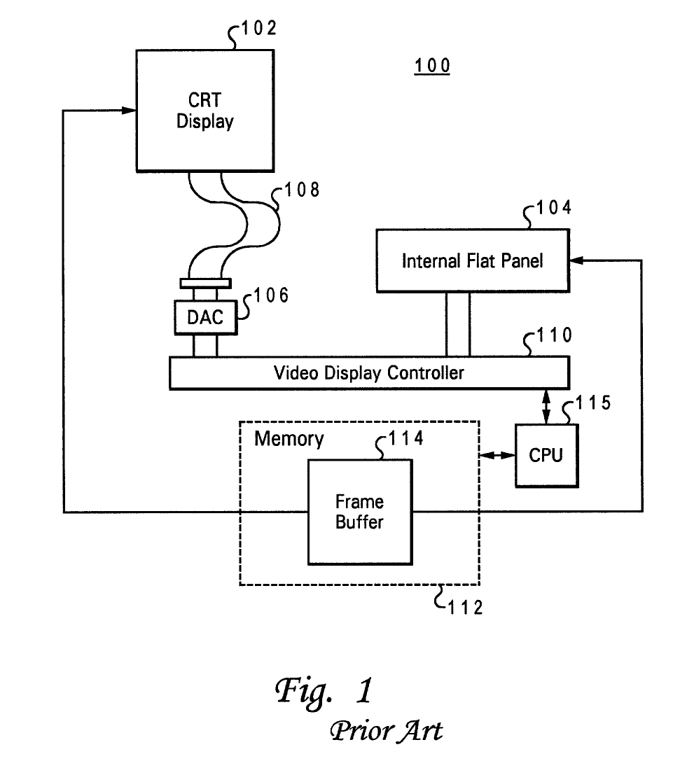

FIG. 2 is a block diagram depicting a split display computer system as configured during dual display mode in accordance with a preferred embodiment of the present invention;

FIG. 3 is a block diagram illustrating the split display computer system shown in FIG. 2 operating in split display mode in accordance with a preferred embodiment of the present invention;

FIG. 4 is flow diagram depicting steps performed within a computer display system in selecting dual display and split display modes in accordance with a preferred embodiment of the present invention; and

FIG. 5 is a flow diagram illustrating steps performed within a computer display system during split display mode in accordance with a preferred embodiment of the present invention.

### DETAILED DESCRIPTION OF THE PREFERRED EMBODIMENT

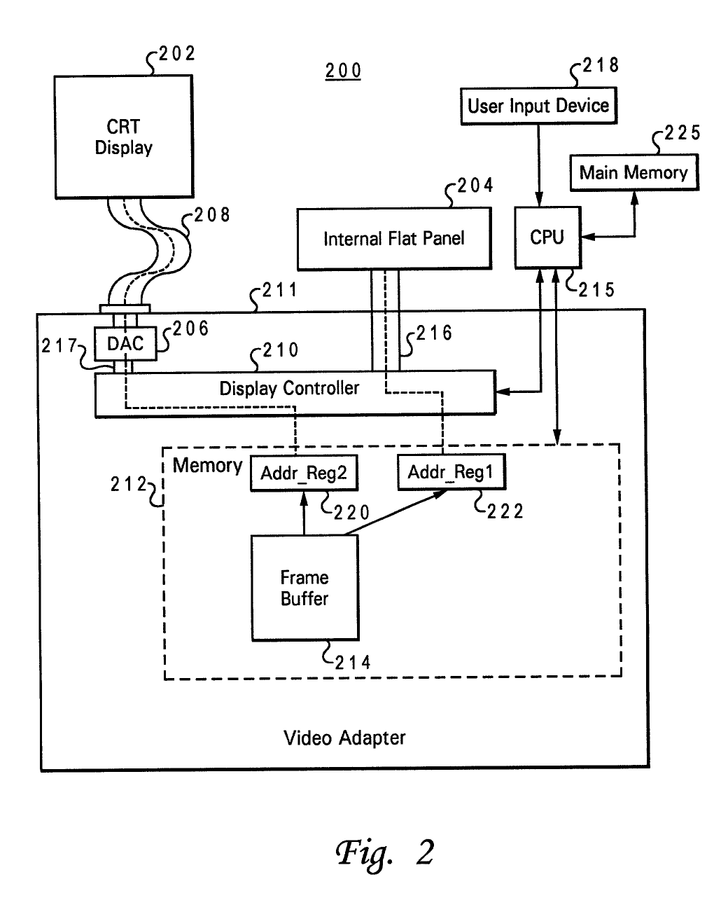

This invention is described in a preferred embodiment in the following description with reference to FIGS. 2 through 5. While this invention is described in terms of the best mode for achieving this invention's objectives, it will be appreciated by those skilled in the art that variations may be accomplished in view of these teachings without deviating from the spirit or scope of the present invention.

Although, the present invention will be described herein in terms of a particular system and particular components, one of ordinary skill in the art will readily recognize that this method and system will operate effectively for other components in a data processing system. The present invention will be described in the context of a computer-aided display system comprising a local liquid crystal display (LCD) for providing a local user (presenter) a visual display of a graphic image file stored within a portable personal computer. As described with reference to the figures herein, the computer-aided display system further includes an external cathode ray tube (CRT) display device for providing a graphic image display to an audience. However, one of ordinary skill in the art will readily recognize that the present invention is also applicable for any situation in which a computer-aided dual display capability is implemented.

With reference now to the figures wherein like reference numerals refer to like and corresponding parts throughout, and in particular with reference to FIG. 2, there is depicted a block diagram illustrating a computer display system 200 as configured during dual display mode in accordance with a preferred embodiment of the present invention. Although not explicitly shown in FIG. 2, it will be understood by those skilled in the art that such a system may be incorporated within a personal computer such as portable lap-top computers commonly utilized for providing computer-aided display presentations. Computer display system 200 includes a video display controller 210 and a frame buffer 214. As illustrated in FIG. 2, frame buffer 214 is incorporated within a dedicated video memory device 212 where an image is stored and manipulated, independent of the computer system's main memory 225. According to various aspects of the present invention, frame buffer 214 and video display controller 210 are interconnected within the video data path of computer display system 200, which is running a presentation application for display on one or both of local LCD device 204 and CRT display device 202. An external interface bus cable 208 connects CRT display device 202 with video display controller 210. Frame buffer 214 captures a frame on a video signal generated by a software graphics application (not depicted) and delivered from a central processing unit (CPU) 215 to video memory device 212. Together, CPU 215, video memory device 212, video display controller 210, and a digital-to-analog converter (DAC) 206 constitute the internal video display data path processing functionality of computer display system 200.

LCD device 204 provides an onboard video display to a local user, while external CRT display device 202 for provides an alternate video display to an audience, for example. The display capabilities of a personal computer in which computer display system 200 is implemented depend on both the logical circuitry (provided by video display controller 210 and video memory 212) and the display apparatus connected therewith.

CPU 215 executes program instructions stored in main memory 225. Data may be manually entered into computer display system 200 via a user input device 218. In one embodiment, user input device 218 is a keyboard from which soft key functions corresponding to program instructions maybe activated. CPU 215 generates data for creating a graphical image for display on either or both of LCD device 204 and CRT display device 202. Video display controller 210 in conjunction with video memory device 212 converts bit-mapped image data from CPU 215 into a suitably converted video signal.

In typical implementations, video display controller 210 and video memory device 212 will be incorporated on a video adapter board 211 that plugs into a personal computer. The dedicated video storage capacity afforded by video memory device 212 helps ensure that the host computer's random access memory (RAM) is not depleted by graphic display storage. In addition, although not depicted in FIG. 2, video adapter 211 may include its own graphics coprocessor for performing graphics-related computations. In a preferred embodiment, video adapter 211 conforms to a widely utilized standard known as Video Graphics Adapter (VGA) or super VGA. CPU 215 generates a bit-mapped image file that is stored in video memory 212 within video adapter 211. Video display controller 210 rasterizes the bit-mapped image to produce an digital signal video signal, which drives LCD device 204 and is converted into an analog signal to be utilized by CRT display device 202.

As depicted in the present embodiment, two distinct buffer address registers 222 and 220 are provided to facilitate controllably independent display modes for local LCD device 204 and external CRT display device 202, respectively. A video data path for local LCD device 204 is determined in accordance with the contents of frame buffer address register 222, while the data path for CRT display device 202 is determined in accordance with the contents of frame buffer address register 220. Video display controller 210 includes two output ports 216 and 217 that deliver display control data to LCD device 204 and CRT display device 202, respectively, from data pointed to by frame buffer address registers 222 and 220, respectively. DAC 206 converts digitally encoded images from video display controller 210 into analog signals that can be displayed by CRT display device 202.

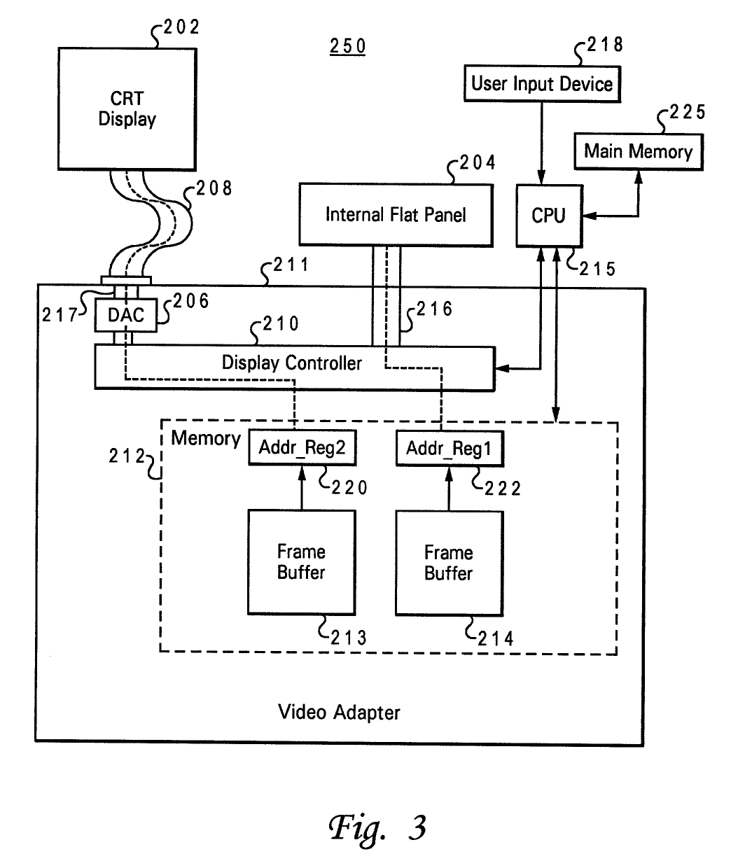

In the depicted embodiment, computer display system 200 is configured to operate in a dual display mode. As utilized herein, “dual display mode” refers to a display configuration wherein both buffer address registers 222 and 220 store pointers from the same frame buffer (frame buffer 214, for example) such that the same image is displayed on both local LCD device 204 and CRT display device 202. In contrast, and as explained with reference to FIGS. 3-5, “split display mode” refers to a display configuration whereby the video data path for CRT display device 202 has been altered such that different images may be displayed on LCD device 204 and CRT display device 202.

In accordance with the depicted embodiment, the default configuration of computer display system 200 includes programming the contents of frame buffer address register 222 to include a pointer from the address of the “active” frame buffer 214. As defined herein, the “active” frame buffer contains the graphical data that is currently selected for display on local LCD device 204. Dual display mode is achieved as illustrated in FIG. 2 by programming the contents of frame buffer address register 220 to include the same pointer as that contained within frame buffer address register 222 (i.e., a pointer from frame buffer 214). In this configuration, the displays of both local LCD device 204 and CRT display device 202 project the same image as determined by the contents of frame buffer 214.

Frame buffer address registers 220 and 222 are designated by CPU 215 as the display access registers for CRT display device 202 and LCD device 204, respectively. In response to a soft key command input from user input device 218 directing activation of dual display mode to CPU 215, video display controller 210 copies the contents of frame buffer address register 222 to frame buffer address register 220. Video display controller 210 reads the pointer contents of frame buffer address registers 220 and 222 to obtain the video data contents of frame buffer 214, which are then displayed on CRT display device 202 and LCD device 204 simultaneously.

Referring now to FIG. 3, there is depicted a block diagram illustrating a computer display system 250 configured in split display mode in accordance with a preferred embodiment of the present invention. Split display mode may be desired by a presenter of a sequential graphic display when, for example, the presenter wishes to preview or possibly even modify a next image prior to displaying the next image to the audience. The embodiment depicted in FIG. 3 allows a presenter to maintain the currently displayed image on external CRT display device 202 while changing the display on local LCD device 204 without the need for duplicate video display controller functionality.

As illustrated in FIG. 3, computer display system 250 includes the same hardware functionality as computer display system 200 with an additionally allocated frame buffer 213. A user wishing to enter split display mode initiates a soft key function command via user input device 218. The soft key function is programmed to reset the contents of frame buffer address register 220 such that the previously stored pointer from frame buffer 214 are replaced by a pointer from frame buffer 213. In various embodiments, the soft key utilized to enter split display mode as depicted in FIG. 3 may include the same or different physical keystroke(s) utilized for enabling the dual display mode configuration illustrated in FIG. 2. In a preferred embodiment of the present invention, the soft key utilized to deploy the split display mode configuration shown in FIG. 3 is programmed to instruct CPU 215 to perform the following sequence of operations with respect to video memory device 212. First, a frame buffer distinct from primary frame buffer 214 is allocated (i.e., frame buffer 213). Next, the contents of primary frame buffer 214 are copied to frame buffer 213. Finally, the pointer from primary frame buffer 214 within frame buffer address register 220 is replaced with an address pointer from frame buffer 213.

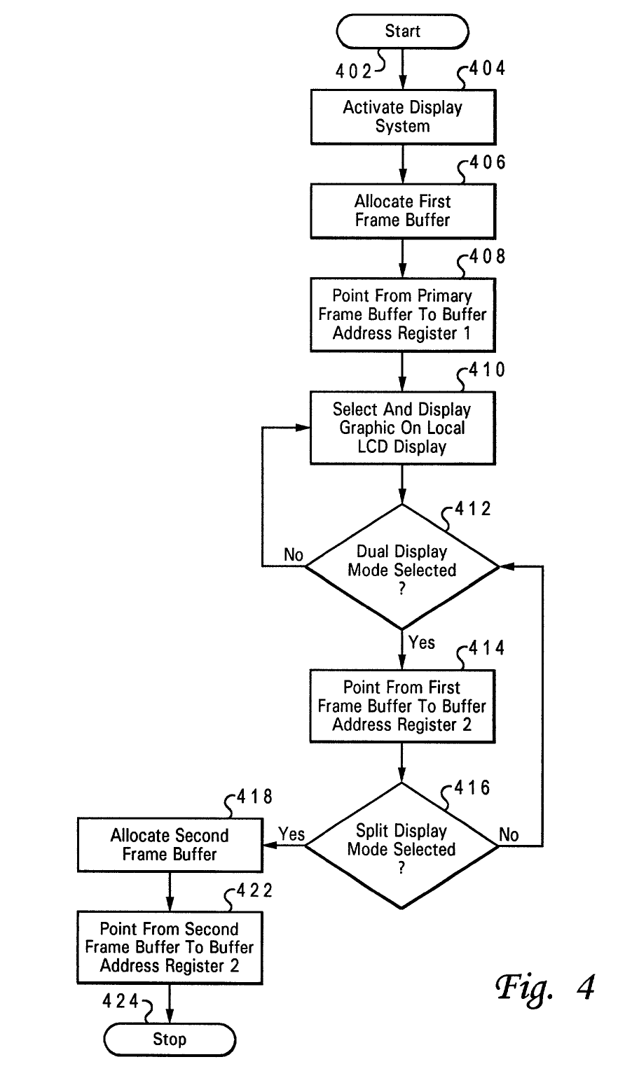

With reference to FIG. 4, there is illustrated a flow diagram depicting steps performed by a computer display system configured as shown in FIGS. 2 and 3 in selecting dual display and split display modes in accordance with a preferred embodiment of the present invention. The display selection process begins as shown at step 402 and proceeds to step 404 wherein the computer display system is activated. Next, as depicted at step 406, a frame buffer, such as frame buffer 214, is allocated and designated as the primary display frame buffer that provides video data to local LCD device 204. A video data path from primary frame buffer 214 to local LCD device 204 is then established by providing an address pointer within frame buffer address register 222 from primary frame buffer 214 (step 408).

Proceeding to step 410, the graphic image file contained within primary frame buffer 214 is locally displayed within LCD device 204. In the context of a computer-aided presentation, a presenter may wish to provide a dual display wherein the image displayed locally on LCD device 204 is simultaneously displayed on external CRT display device 202. To this end, and as illustrated at steps 412 and 414, a pointer is provided within frame buffer address register 220 to point from primary frame buffer 214. The address pointing configuration resulting from the operations performed at step 414 is depicted in FIG. 2. As long as the user wishes to maintain only the local display on LCD device 204 active the process will remain at step 410.

At any given time during a computer-aided presentation, display independence between local LCD device 204 and external CRT display device 202 may be desirable. For example, the presenter may wish to freeze the current image displayed to the audience on CRT display device 202 while privately viewing and possibly modifying an upcoming display frame image on LCD device 204. There are numerous additional examples of situations in which it is desired to provide different images on the local and external display devices. If display independence is desired a split mode utility is selected via a softkey user input, and in response thereto, an available and possibly pre-designated buffer within video memory 212 is allocated as an alternate frame buffer (i.e., frame buffer 213) as depicted at steps 416 and 418. Also in response to the selection of split display mode at step 416, the contents of buffer address register 220 are replaced with a pointer from the allocated alternate frame buffer. As a result of the operations depicted at steps 416-422, the computer display system will be configured as depicted in FIG. 3.

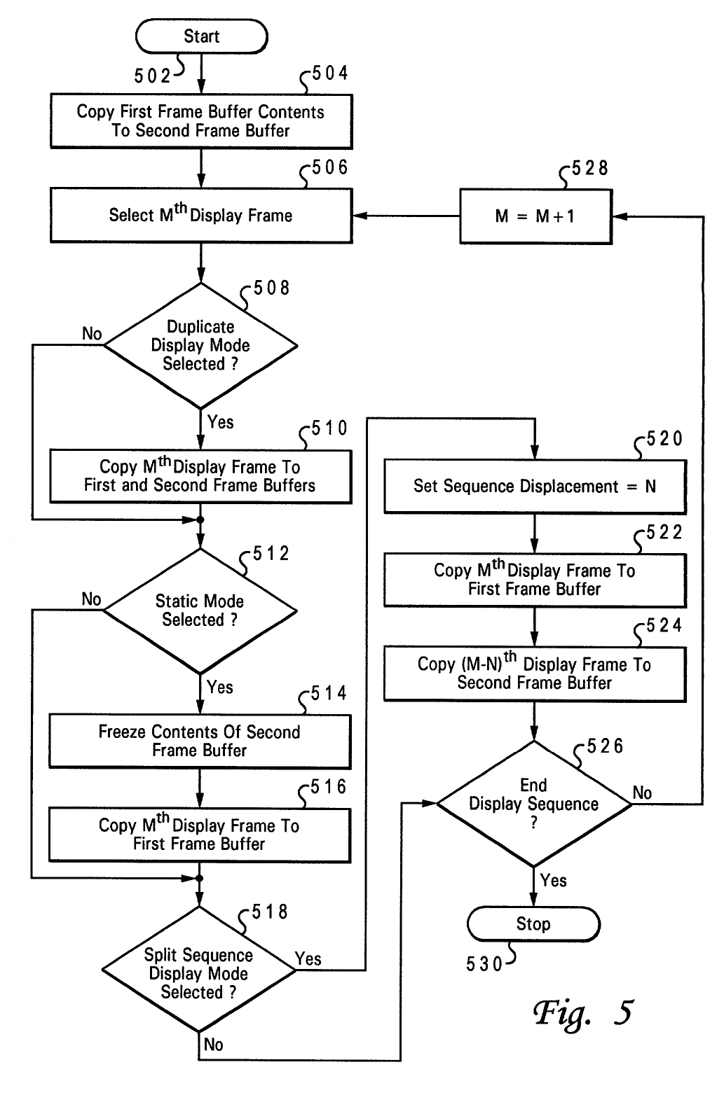

With reference to FIG. 5, there is depicted a flow diagram illustrating steps performed while selecting alternate split display modes within computer display system 250 in accordance with a preferred embodiment of the present invention. It is assumed that the split display mode process shown in FIG. 5 is performed after split mode has been selected within computer display system 250 in accordance with the process depicted in FIG. 4. The process begins as shown at steps 502 with 504 with the video data contents of frame buffer 214 being copied to alternate frame buffer 213. Next, as illustrated at step 506, the next (M^{th}) display frame is selected by the local user, typically as a keyboard or pointer device user input entry.

As a separate or combined user input command, one of three possible display modes is selected for processing the current and next frame buffer contents. The selection among these options is illustrated at steps 508 (selection of duplicate display mode), 512 (selection of static display mode, and 518 (selection of split sequence display mode). As utilized herein, “duplicate display mode” refers to a display configuration in which the user currently requires a duplicate visual display on local LCD device 204 and external CRT display device 202, while maintaining independent display capability. In such a case, and as depicted at step 510, the video data within the M^{th} display frame replaces the current frame buffered within both of frame buffers 214 and 213.

“Static display mode” is selected when the local user wishes to maintain the current displayed image on either local LCD device 204 or external CRT display device 202 while sequencing to the next display frame on the other display device. As illustrated at steps 512, 514 and 516, in response to a user input selecting static display mode, the present content of alternate display frame buffer 213 is maintained while the next display frame is copied to display frame buffer 214. As long as static mode is maintained, the local user may sequence through and privately view any number display frames on local LCD device 204 while maintaining the same display on external CRT display device 202. It should be noted that although the present embodiment represents a sequence to a “next” display frame (presumably within a display sequence), one skilled in the art will appreciate that the inventive concept may be readily extended to privately viewing one or more “previous” display frames while the external display remains static.

In addition to the foregoing duplicate and static split display modes, it may often be convenient to provide an option whereby a presenter of a sequential visual display can pre-select a given offset value by which the two displays will automatically be offset as the sequence proceeds. As illustrated at steps 518 and 520, in response split sequence mode being selected (via a softkey input, for example), the local user inputs a desired sequence offset, N. Proceeding to steps 522 and 524, M^{th} display frame data is copied to display frame buffer 214 for private viewing by a local user on local LCD device 204, while the (M-N)^{th} display frame is copied into display frame buffer 213 for external viewing by the audience. It should be noted that step 524 can be replaced by simply replacing the contents of address register 220 to include a pointer from a display frame buffer that includes the (M-N)^{th} display frame. The display frames may be stored in a buffer queue (not depicted) within video memory 212. The sequence is incremented and repeats as depicted at steps 528 and 506 until the end of the display sequence is reached at which time the process terminates as illustrated at steps 526 and 528. It should be noted that during a display presentation the three split display modes described herein may be combined in any combination at any given step in the display sequence.

A method and system has been disclosed for enabling a dual display mode or a split display mode configuration in a computer-aided display system. Software written according to the present invention is to be stored in some form of computer readable medium, such as memory, CD-ROM or transmitted over a network, and executed by a processor. Alternatively, some of all of the present invention could be implemented in hardware. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

While the invention has been particularly shown and described with reference to a preferred embodiment, it will be understood by those skilled in the art that various changes in form and detail may be made therein without departing from the spirit and scope of the invention.

What is claimed is:

1. A method applicable within a computer display system for providing display independence between a first display device and a second display device, wherein said first and second display devices are controlled by a common video display controller, said method comprising:
providing a first address register that is accessible by said common video display controller to display within said first display device a graphic representation of data pointed to by an address within said first address register; and
providing a second address register that is accessible by said common video display controller to display within said second display device a graphic representation of data pointed to by an address within said second address register, such that displays within said first and second display devices are independently controllable.

2. The method of claim 1, further comprising:
allocating a first frame buffer; and
selecting a dual display mode, and in response thereto, programming said first and second address registers to point to said first frame buffer.

3. The method of claim 2, wherein said programming said first and second address registers to point to said first frame buffer during a dual display mode is followed by, in response to said first and second address registers pointing to said first frame buffer, displaying video data from said first frame buffer within said first and second display devices.

4. The method of claim 1, further comprising:
selecting a split display mode, and in response thereto:
allocating a second frame buffer;
copying the contents of said first frame buffer to said second frame buffer; and
replacing the contents of said second address register to point to said second frame buffer.

5. The method of claim 4, wherein in response to said copying the contents of said first frame buffer to said second frame buffer and adjusting said second address register to point to said second frame buffer, said method further comprises:
delivering video data corresponding to the contents of said first frame buffer to said first display device; and
delivering video data corresponding to the contents of said second frame buffer to said second display device.

6. The method of claim 4, wherein said second frame buffer currently stores a display frame, said method further comprising:
selecting an alternate display frame within a video memory device; and
actuating a static display mode, and in response thereto:
maintaining said display frame within said second frame buffer; and
copying said alternate display frame within said first frame buffer.

7. The method of claim 4, wherein said computer display system includes a display sequence comprising a plurality of display frames within a video memory device, said method further comprising:
selecting an M^{th} display frame from within said display sequence;
actuating a split sequence display mode;
setting a sequence displacement value equal to N; and
in response to said actuating a split sequence display mode and setting a sequence displacement value equal to N:
copying said M^{th} display frame into said first frame buffer; and
copying an (M-N)^{th} display frame into said second frame buffer.

8. An apparatus applicable within a computer display system for providing display independence between a first display device and a second display device, wherein said first and second display devices are controlled by a common video display controller, said apparatus comprising:
processing means for providing a first address register that is accessible by said common video display controller to display within said first display device a graphic representation of data pointed to by an address within said first address register; and
processing means for providing a second address register that is accessible by said common video display controller to display within said second display device a graphic representation of data pointed to by an address within said second address register, such that displays within said first and second display devices are independently controllable.

9. The apparatus of claim 8, further comprising:
processing means for allocating a first frame buffer; and
processing means for selecting a dual display mode, and in response thereto, programming said first and second address registers to point to said first frame buffer.

10. The apparatus of claim 9, further comprising processing means responsive to said first and second address registers pointing to said first frame buffer for displaying video data from said first frame buffer within said first and second display devices.

11. The apparatus of claim 8, further comprising:
processing means for selecting a split display mode;
processing means for allocating a second frame buffer;
processing means for copying the contents of said first frame buffer to said second frame buffer; and
processing means for replacing the contents of said second address register to point to said second frame buffer.

12. The apparatus of claim 11, further comprising processing means responsive to copying the contents of said first frame buffer to said second frame buffer and adjusting said second address register to point to said second frame buffer, for:
delivering video data corresponding to the contents of said first frame buffer to said first display device; and
delivering video data corresponding to the contents of said second frame buffer to said second display device.

13. The apparatus of claim 11, wherein said second frame buffer currently stores a display frame, said apparatus further comprising:
processing means for selecting an alternate display frame within a video memory device;
processing means for actuating a static display mode;
processing means for maintaining said display frame within said second frame buffer; and
processing means for copying said alternate display frame within said first frame buffer.

14. The apparatus of claim 11, wherein said computer display system includes a display sequence comprising a plurality of display frames within a video memory device, said apparatus further comprising:
processing means for selecting an M^{th} display frame from within said display sequence;
processing means for actuating a split sequence display mode;
processing means for setting a sequence displacement value equal to N; and
processing means responsive to said actuating a split sequence display mode and setting a sequence displacement value equal to N for:
copying said M^{th} display frame into said first frame buffer; and
copying an (M-N)^{th} display frame into said second frame buffer.

15. The apparatus of claim 8, wherein said computer display system includes a central processing unit, said apparatus further comprising processing means for processing data within said central processing unit for generating video image data displayable on said first and second display devices.

16. The apparatus of claim 8, wherein said second display device is a cathode ray tube (CRT) display device, said apparatus further comprising processing means for converting digitally encoded data addressed by said second frame buffer address register into analog data for presentation on said CRT display device.

17. A program product applicable within a computer display system for providing display independence between a first display device and a second display device, wherein said first and second display devices are controlled by a common video display controller, said program product comprising:
instruction means for providing a first address register that is accessible by said common video display controller to display within said first display device a graphic representation of data pointed to by an address within said first address register; and
instruction means for providing a second address register that is accessible by said common video display controller to display within said second display device a graphic representation of data pointed to by an address within said second address register, such that displays within said first and second display devices are independently controllable.

18. The program product of claim 17, further comprising:
instruction means for allocating a first frame buffer; and
instruction means for selecting a dual display mode, and in response thereto, programming said first and second address registers to point to said first frame buffer.

19. The program product of claim 18, further comprising instruction means responsive to said first and second address registers pointing to said first frame buffer for displaying video data from said first frame buffer within said first and second display devices.

20. The program product of claim 17, further comprising:
instruction means for selecting a split display mode;
instruction means for allocating a second frame buffer;
instruction means for copying the contents of said first frame buffer to said second frame buffer; and
instruction means for replacing the contents of said second address register to point to said second frame buffer.

21. The program product of claim 20, further comprising instruction means responsive to copying the contents of said first frame buffer to said second frame buffer and adjusting said second address register to point to said second frame buffer, for:
delivering video data corresponding to the contents of said first frame buffer to said first display device; and
delivering video data corresponding to the contents of said second frame buffer to said second display device.

22. The program product of claim 20, wherein said second frame buffer currently stores a display frame, said program product further comprising:
instruction means for selecting an alternate display frame within a video memory device;
instruction means for actuating a static display mode;
instruction means for maintaining said display frame within said second frame buffer; and
instruction means for copying said alternate display frame within said first frame buffer.

23. The program product of claim 20, wherein said computer display system includes a display sequence comprising a plurality of display frames within a video memory device, said program product further comprising:
instruction means for selecting an M^{th} display frame from within said display sequence;
instruction means for actuating a split sequence display mode;
instruction means for setting a sequence displacement value equal to N; and
instruction means responsive to said actuating a split sequence display mode and setting a sequence displacement value equal to N for:
copying said M^{th} display frame into said first frame buffer; and
copying an (M-N)^{th} display frame into said second frame buffer.
